(19) United States
(12) Patent Application Publication
(10) Pub. No.: US 2021/0245338 A1
(43) Pub. Date: Aug. 12, 2021

(54) FASTENER INSERTION SYSTEM

(71) Applicant: Raytheon Company, Waltham, MA (US)

(72) Inventors: Blair Simons, Waltham, MA (US); Alexandra Cintron, Waltham, MA (US)

(73) Assignee: Raytheon Company, Waltham, MA (US)

(21) Appl. No.: 16/785,116

(22) Filed: Feb. 7, 2020

(51) Int. Cl. B25B 23/10; B25B 23/14

(52) U.S. Cl. CPC B25B 23/10; B25B 23/14

(57) ABSTRACT

A gripper/driver combination attached to a linear slide interfaces with a torque controller and an automation system. A fastener ready to be installed is presented and the gripper/driver combination is moved to capture the fastener. The fastener is held in place between the gripper and the driver. The captured fastener is then located over a hole where the fastener is to be inserted. Once in place, the fastener is inserted into the hole, and the driver will begin operating, for example, in the case of a screw fastener, the driver will be commanded to start thread engagement and rundown. Once the threads are engaged, the gripper will be removed, allowing the driver to complete the process.

### BACKGROUND

In the automated assembly industry, known systems are readily available for the automated feeding and installing of relatively simple fasteners, e.g., a screw or a bolt, into relatively simple holes or openings. More complex fasteners, e.g., fasteners that include a hardware stackup, e.g., one or more washers, present challenges that are difficult to overcome.

Typically, a complex fastener is dealt with by removing the complexity of the hardware stackup. This approach, however, can pose issues for legacy designs or difficult to modify designs. As a result, automating the insertion of complex fasteners, or the insertion of fasteners into complex holes or openings, results in complicated, and often times, unreliable and temperamental machines or operations.

Further, there is no solution for the automated insertion of a fastener, either simple or complex, into a hole or opening with a complex geometry due to either difficult access or a challenging orientation.

What is needed is a mechanism for automating the insertion of a complex fastener into an opening and for automating the insertion of a fastener, simple or complex, into a complex opening.

### SUMMARY

In one aspect of the present disclosure, there is a fastener insertion system for inserting a fastener assembly, comprising: a rail; a driver controller, coupled to the rail, configured to move along the rail; a gripper controller, coupled to the rail, configured to move along the rail; a driver coupled to the driver controller; a gripper coupled to the gripper controller; and an insertion system controller, coupled to the driver controller and the gripper controller. The insertion system controller is configured to: move the driver controller and the gripper controller along the rail to capture the fastener assembly between the gripper and the driver; operate the driver controller and the gripper controller to move the captured fastener assembly to an insertion position for a target location; operate the driver controller to cause the driver to apply a force to the fastener assembly in order to insert the fastener assembly at the target location; and operate the gripper controller to decouple the gripper from the fastener assembly prior to a complete insertion of the fastener assembly in the target location.

In another aspect of the present disclosure, there is a method of installing a fastener assembly into a target location on a component, the method comprising: capturing a portion of the fastener assembly between a driver and a gripper; moving the captured fastener assembly into an insertion position for the target location; initiating insertion of the fastener assembly into the target location; at a predetermined point prior to a complete insertion of the fastener assembly into the target location, decoupling the gripper from the fastener assembly; and subsequent to decoupling the gripper from the fastener assembly, completing insertion of the fastener assembly into the target location.

### BRIEF DESCRIPTION OF THE DRAWINGS

Various aspects of the present disclosure are discussed below with reference to the accompanying Figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The Figures are provided for the purposes of illustration and explanation and are not intended as a definition of the limits of the disclosure. In the Figures:

FIG. 1 is a representation of a complex fastener and its corresponding insertion target location;

FIGS. 2A-2E represent a system in accordance with an aspect of the present disclosure;

FIGS. 3A-3D represent a system in accordance with another aspect of the present disclosure;

FIG. 4 is a block diagram of a system in accordance with an aspect of the present disclosure; and

FIG. 5 is a method in accordance with another aspect of the present disclosure.

### DETAILED DESCRIPTION

In the following description, details are set forth in order to provide a thorough understanding of the aspects of the disclosure. It will be understood by those of ordinary skill in the art that these may be practiced without some of these specific details. In other instances, well-known methods, procedures, components and structures may not have been described in detail so as not to obscure the aspects of the disclosure.

It is to be understood that the disclosure is not limited in its application to the details of construction and the arrangement of the components set forth in the following description or illustrated in the drawings as it is capable of implementations or of being practiced or carried out in other various ways. Also, it is to be understood that the phraseology and terminology employed herein are for the purpose of description only and should not be regarded as limiting.

Certain features, which are, for clarity, described in the context of separate implementations, may also be provided in combination in a single implementation. Conversely, various features, which are, for brevity, described in the context of a single implementation, may also be provided separately or in any suitable sub-combination.

It should be noted that, where used, “top,” “bottom,” “upper,” “lower,” etc., are merely for explaining the relative placement of components described herein. These relative placement descriptions are not meant to limit the claims with respect to a direction of gravity or a horizon.

Generally, and as will be described in more detail below, aspects of the present disclosure provide a gripper/driver combination attached to a linear slide interfacing with a torque controller and an automation system. A fastener ready to be installed is presented, for example, by a known pick or escapement nest, and the gripper/driver combination is moved to capture the fastener. The fastener is held in place between the gripper and the driver. The automation system then locates the captured fastener over a location, usually a hole, where the fastener is to be inserted. Once in place, the fastener is inserted into the hole, and the driver will begin operating, for example, in the case of a screw fastener, the driver will be commanded to start thread engagement and rundown. Once the threads are engaged, the gripper will be removed, allowing the driver to complete the process.

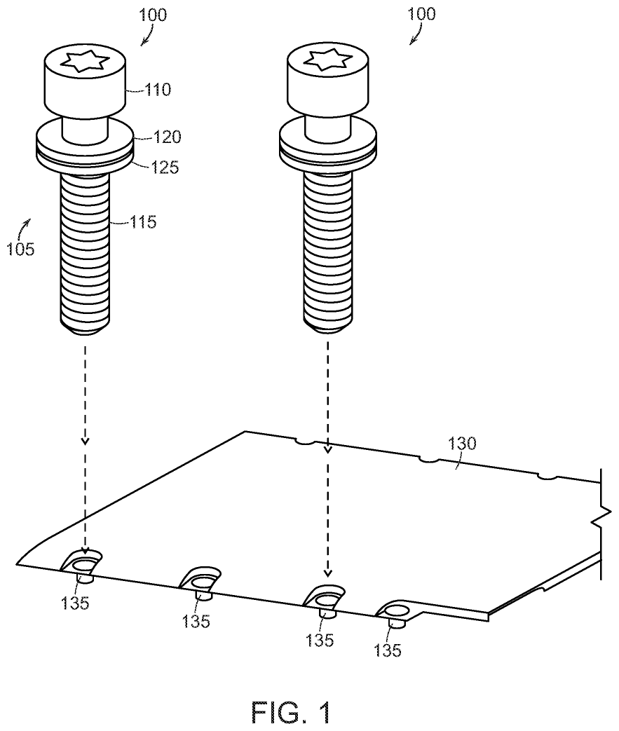

As shown in FIG. 1, a fastener assembly 100 includes a screw 105 with a screw head 110 and a threaded shaft 115. It should be noted that the reference to a screw 105 herein is for explanatory purposes only and aspects of the present disclosure are not limited thereto. A first stackup part 120 and a second stackup part 125 are disposed about the shaft 115. The stackup parts 120, 125 can comprise a washer, a locking washer, a spacer, etc.

As is well understood by those of ordinary skill in the art, the fastener assembly 100 is installed to couple parts together. Accordingly, in one non-limiting example, a component 130, for example, but not limited to, a cover portion of a device or system, has a plurality of locations 135, for example, a threaded opening, to receive a respective assembly 100.

In one aspect of the present disclosure, a fastener insertion system 200 includes a rail 210 along which a driver controller 220 and a gripper controller 230 can travel in directions shown by arrow A-A. A driver 240 is coupled to the driver controller 220 and a gripper 250 is coupled to the gripper controller 230. As will be described in more detail below, the driver controller 220 can move the driver 240 in directions shown by the arrow B-B and control a torque applied by the driver 240. The gripper controller 230 can move the gripper 250 in directions shown by the arrow C-C. In addition, an escapement nest 260 is provided to hold the fastener assembly 100 for processing.

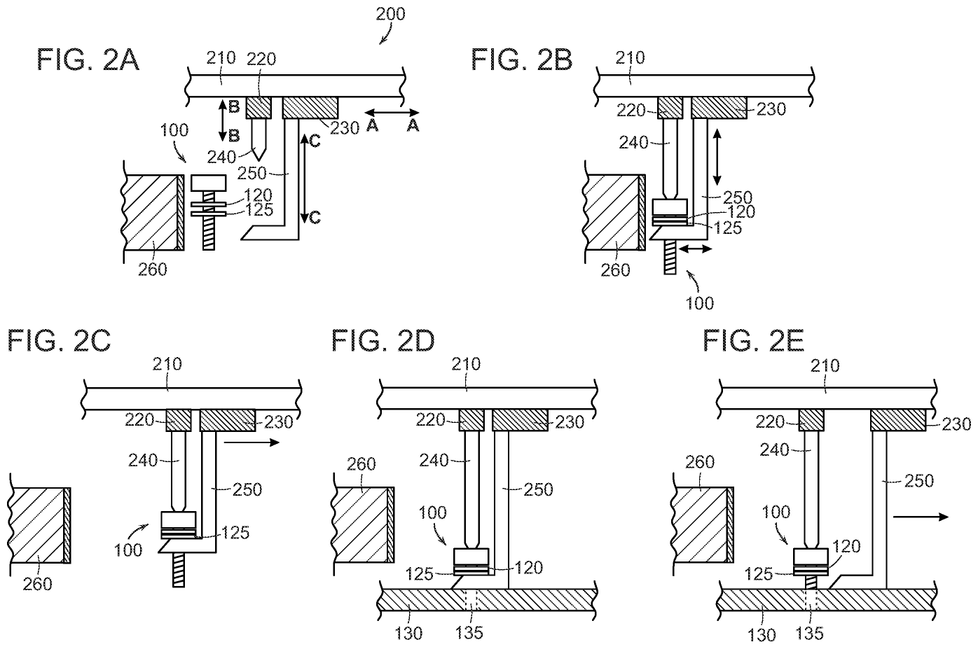

In a first phase of operation, the driver controller 220 moves the driver 240 and the gripper controller 230 moves the gripper 250 in order to capture the fastener assembly 100 between the gripper 250 and the driver 240, as shown in FIG. 2B. More specifically, the screw head 110, the first stackup part 120 and the second stackup part 125, are kept in place between the driver 240 and the gripper 250. Advantageously, all parts of the complex fastener assembly 100 are kept together.

Subsequently, as shown in FIG. 2C, the captured fastener assembly 100 is moved away from the escapement nest 260. More specifically, the captured fastener assembly 100 is moved toward and over, for example, the location 135 in the component 130, as shown in FIG. 2D.

Once positioned over the location 135, the driver controller 220 and the gripper controller 230 move the gripper 240 and the driver 250 to position a distal end of the shaft 115 in the opening 135. The driver controller 220 then operates the driver 240 to install the fastener assembly 100 in the opening 135. Accordingly, for a screw-based assembly 100, the driver 240 is operated to apply a torque to turn or rotate the assembly 100. At a predetermined point prior to complete insertion, as shown in FIG. 2E, the gripper controller 230 moves the gripper 250 out from between the screw head 110 and the component 130. Once the gripper 250 is removed, the driver controller 220 completes the installation of the assembly in the component 130.

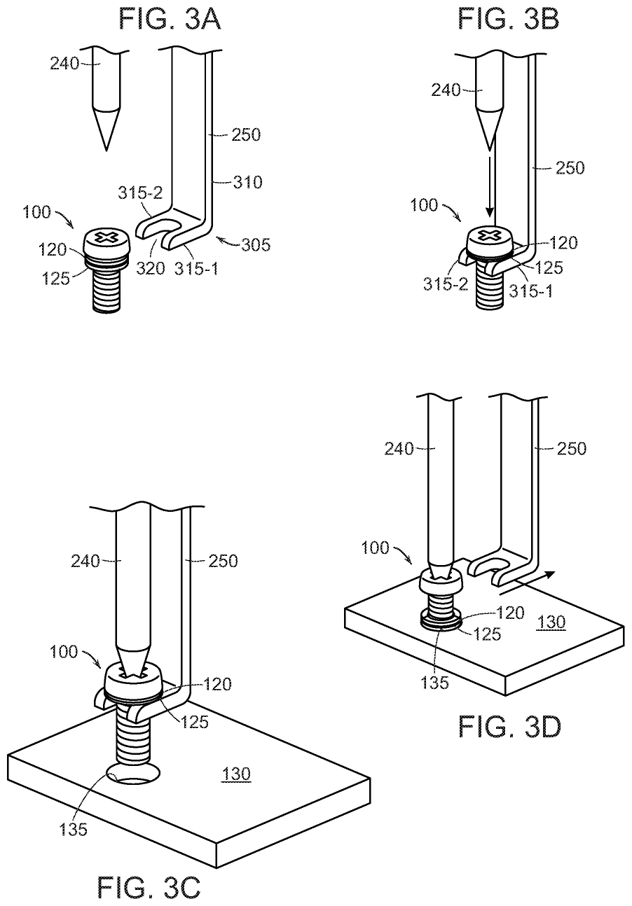

Referring to FIGS. 3A-3D, in one aspect of the present disclosure, the gripper 250 has a distal end 305 that is at a right angle to a longitudinal portion 310 of the gripper 250. The distal end 305 has two prongs 315-1, 315-2 between which an opening 320 is defined. The two prongs 315-1, 315-2, as shown in FIG. 3B, slide under the first and second stackup parts 120, 125. In one embodiment, each end of the prong 315-x can have a ramped, i.e., beveled or inclined, surface to facilitate placement under the stackup parts. Then driver 240 is positioned against the screw head 110 to keep the fastener assembly 100 in place, as shown in FIG. 3C. Further, in one embodiment, the prongs 315 are configured to not extend beyond the diameter of fastener head. Once the fastener assembly 100 is in place, and prior to complete installation, the prongs 315-1, 315-2, i.e., the gripper 250, are withdrawn and the installation is then completed, as shown in FIG. 3D.

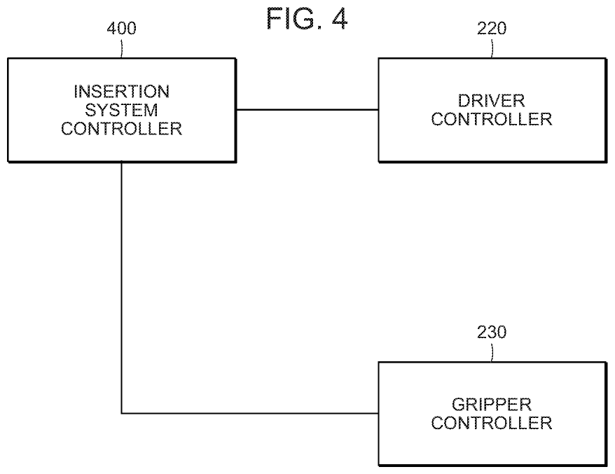

Referring to FIG. 4, the fastener insertion system 200 can include an insertion system controller 400 coupled to the driver controller 220 and the gripper controller 230. The controller 400 can comprise a CPU, RAM, ROM, a mass storage device, for example, a disk drive, an I/O interface to couple to, for example, a display, a keyboard/mouse or a touchscreen, or the like, and a network interface module to connect to, either wirelessly or via a wired connection, the Internet. All of these modules can be in communication with each other through a bus. The CPU can execute an operating system to operate and communicate with these various components.

Further, various implementations of the herein-described systems and methods may be provided in digital electronic circuitry, in computer hardware, firmware, and/or software. An implementation can be as a computer program product, e.g., a computer program tangibly embodied in an information carrier that is executed by the CPU. The implementation can, for example, be in a machine-readable storage device, for execution by, or to control the operation of, a data processing apparatus. The implementation can, for example, be a programmable processor, a computer, and/or multiple computers.

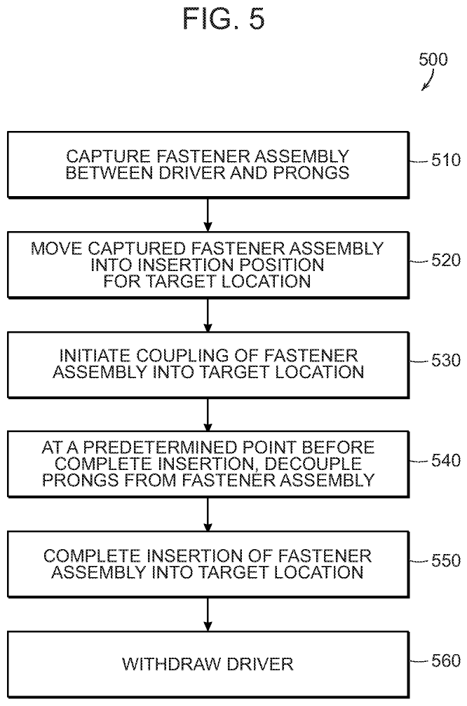

Referring now to FIG. 5, a method 500 of installing a fastener, in accordance with an aspect of the present disclosure, includes capturing the fastener assembly 100 between the driver and the prongs 315, step 510. Subsequently, step 520, the captured fastener assembly 100 is moved into an insertion position for the target location. The coupling of the fastener assembly 100 into the target location 135 is initiated, step 530. At a predetermined point prior to complete insertion, the prongs are decoupled from the fastener assembly, step 540. Once the prongs 315 have been withdrawn, insertion of the fastener assembly 100 into the target location 135 is completed, step 550 and the driver 240 is then withdrawn, step 560.

In accordance with an aspect of the present disclosure, the system may determine when the prongs 315 are to be decoupled by counting a number of rotations of the fastener assembly 100. This would be a function of the pitch of the threads as well as the length of the screw shaft 115. In another aspect of the present disclosure, the determination as to when to withdraw the prongs 315 may be based on detecting an increase in the torque necessary to install the fastener assembly 100, i.e., the torque being applied, recognizing that the torque may increase the farther the shaft 115 is inserted into the location 135. Once the applied torque is detected as being at least a predetermined threshold value, the prongs 315 are withdrawn.

It should be noted, that depending on the speed at which the fastener assembly 100 is being driven into the target location 135, the prongs 315 can be withdrawn as the torque continues to be applied or the rotation of the fastener assembly 100 may be paused. Further, the rotation speed may be slowed or otherwise altered once the predetermined torque threshold has been detected to allow for both of the removal of the prongs 315 and to avoid damage to the target location 135 or the fastener assembly 100. Of course, one of ordinary skill in the art will understand that there can be a predefined torque driving profile for each type of fastener assembly 100.

Further, while the driver controller 220 and the gripper controller 230 are shown as separately moving elements on the rail 210, it is to be understood that the these controllers could be on a common base that moves along the rail 210. Accordingly, each of the driver controller 220 and the gripper controller 230 would be movable on the base and separately from each other, thus achieving the same functions as described above.

Advantageously, aspects of the present disclosure can be adapted to accommodate any screw size, any screw style, for example, but not limited to, pan, flathead, flanged, etc., as well as any drive style such as Philips or Torx®, in addition to fasteners 100 made from any material such as metal or plastic. Other types of fasteners, for example, push lock or clevis pins, i.e., any type of fastener with or without a stackup of components can be inserted by aspects of the present disclosure. In addition, aspects of the present disclosure can handle fasteners with shanks that are so short there is no access to grip by the fastener shank and still be able to engage the threads at the target location. Still further, aspects of the present disclosure can place fasteners in surfaces with counterbores, countersinks and any combinations thereof.

The present disclosure is illustratively described above in reference to the disclosed implementations. Various modifications and changes may be made to the disclosed implementations by persons skilled in the art without departing from the scope of the present disclosure as defined in the appended claims.

What is claimed is:

1. A method of installing a fastener assembly into a target location on a component, the method comprising:
capturing a portion of the fastener assembly between a driver and a gripper;
moving the captured fastener assembly into an insertion position for the target location;
initiating insertion of the fastener assembly into the target location;
at a predetermined point prior to a complete insertion of the fastener assembly into the target location, decoupled the gripper from the fastener assembly; and
subsequent to decoupling the gripper from the fastener assembly, completing insertion of the fastener assembly into the target location.

2. The method of claim 1, further comprising:
measuring an amount of torque currently being applied to the fastener assembly; and
determining the predetermined point as a function of the measured amount of currently applied torque.

3. The method of claim 2, wherein determining the predetermined point comprises:
comparing the measured amount of torque currently being applied to a predetermined threshold value.

4. The method of claim 1, wherein the fastener assembly comprises a threaded screw, the method further comprising:
determining the predetermined point as a function of a current number of rotations of the threaded screw into the target location.

5. The method of claim 4, further comprising:
determining the predetermined point as a function of a length and a pitch of the threaded screw.

6. The method of claim 4, further comprising:
identifying a fastener type associated with the fastener assembly; and
determining a predetermined driving torque profile as a function of the determined fastener type,
wherein the predetermined driving torque profile comprises parameters for initiating insertion of the fastener assembly and parameters for defining the predetermined point to decouple the gripper from the fastener assembly.

7. The method of claim 1, wherein the fastener assembly comprises a shank, the method further comprising:
determining the predetermined point to decouple the gripper from the fastener assembly as a function of a length of the shank.

8. The method of claim 1, further comprising:
identifying a fastener type associated with the fastener assembly; and
determining a predetermined driving force profile as a function of the determined fastener type,
wherein the predetermined driving force profile comprises parameters for initiating insertion of the fastener assembly and parameters for defining the predetermined point to decouple the gripper from the fastener assembly.

9. A fastener insertion system for inserting a fastener assembly, comprising:
a rail;
a driver controller, coupled to the rail, configured to move along the rail;
a gripper controller, coupled to the rail, configured to move along the rail;
a driver coupled to the driver controller;
a gripper coupled to the gripper controller; and
an insertion system controller, coupled to the driver controller and the gripper controller, configured to:
move the driver controller and the gripper controller along the rail to capture the fastener assembly between the gripper and the driver;
operate the driver controller and the gripper controller to move the captured fastener assembly to an insertion position for a target location;
operate the driver controller to cause the driver to apply a force to the fastener assembly in order to insert the fastener assembly at the target location; and
operate the gripper controller to decouple the gripper from the fastener assembly prior to a complete insertion of the fastener assembly in the target location.

10. The fastener insertion system of claim 9, wherein the insertion system controller is further configured to:
initiate insertion of the fastener assembly into the target location by applying a torque force to the fastener assembly; and
determine a predetermined point prior to the complete insertion of the fastener assembly into the target location at which to decouple the gripper from the fastener assembly.

11. The fastener insertion system of claim 10, wherein the fastener assembly comprises a threaded screw and wherein the insertion system controller is further configured to:
determine the predetermined point as a function of a number of rotations of the threaded screw.

12. The fastener insertion system of claim 10, further comprising:
identifying a fastener type associated with the fastener assembly; and
determining a predetermined driving torque profile as a function of the determined fastener type,
wherein the predetermined driving torque profile comprises parameters for initiating insertion of the fastener assembly and parameters for defining the predetermined point to decouple the gripper from the fastener assembly.

13. The fastener insertion system of claim 10, wherein the insertion system controller is further configured to:
measure an amount of torque currently being applied to the fastener assembly; and
determine the predetermined point as a function of the measured amount of currently applied torque.

14. The fastener insertion system of claim 13, wherein the insertion system controller is further configured to determine the predetermined point by:
comparing the measured amount of torque currently being applied to a predetermined threshold value.

15. The fastener insertion system of claim 9, wherein the fastener assembly comprises a shank, the method further comprising:
determining the predetermined point to decouple the gripper from the fastener assembly as a function of a length of the shank.

16. The fastener insertion system of claim 9, further comprising:
identifying a fastener type associated with the fastener assembly; and
determining a predetermined driving force profile as a function of the determined fastener type,
wherein the predetermined driving force profile comprises parameters for initiating insertion of the fastener assembly and parameters for defining the predetermined point to decouple the gripper from the fastener assembly.
